(19) United States
(12) Patent Application Publication
(10) Pub. No.: US 2012/0249067 A1
(43) Pub. Date: Oct. 4, 2012

(54) APPARATUS FOR CORRECTING A DC BIAS FOR LEAKAGE CURRENT

(75) Inventors: David A. Hein, Sterling Heights, MI (US); Paul Goelz, Rochester Hills, MI (US)

(73) Assignee: LEAR CORPORATION, Southfield, MI (US)

(21) Appl. No.: 13/329,395

(22) Filed: Dec. 19, 2011

Related U.S. Application Data
(60) Provisional application No. 61/469,964, filed on Mar. 31, 2011.

(51) Int. Cl. H02J 7/00

(52) U.S. Cl. 320/109; 320/137

(57) ABSTRACT

An apparatus for correcting leakage current during a vehicle charging operation is provided. The apparatus comprises a balance circuit configured to receive a sensed current indicative of a vehicle leakage current in response to an external power source providing a charging current to a vehicle. The vehicle leakage current includes a first leakage component and a second leakage component. The balance circuit is further configured to generate a first voltage value that corresponds to a negative value of the first leakage component and to provide a second voltage value that generally corresponds to a positive value of the first leakage component. The balance circuit is further configured to apply the second voltage value to the first voltage value to substantially remove the first leakage component from the vehicle leakage current.

### CROSS-REFERENCE TO RELATED APPLICATIONS

This application claims the benefit of U.S. provisional Application No. 61/469,964 filed on Mar. 31, 2011, the disclosure of which is hereby incorporated by reference in its entirety.

### TECHNICAL FIELD

Embodiments of the present disclosure generally relate to an apparatus for correcting a direct current (DC) bias for leakage current.

### BACKGROUND

It is known to detect leakage current for vehicle applications. One example for detecting leakage current in a charging cable for an electric vehicle is set forth below.

International Publication No: WO 2010/049775 A2 to Mukai et al. discloses a charging cable for an electric vehicle, which includes a power plug adapted to be detachably connected to a power socket of a commercial power source. The charging cable includes a temperature detecting unit for detecting a temperature of the power plug and a cable connector adapted to be detachably connected to an electric vehicle for supplying a charging current to a battery of the electric vehicle. The charging cable further includes a switching unit for opening and closing a current path between the power plug and the cable connector. The charging cable further includes a leakage detecting unit for detecting an electric leakage based on a current flowing through the current path and a power cutoff unit for opening the switching unit when the detected temperature of the temperature detection means exceeds a threshold value or when the leakage detection means detects the electric leakage.

### SUMMARY

An apparatus for correcting leakage current during a vehicle charging operation is provided. The apparatus comprises a balance circuit configured to receive a sensed current indicative of a vehicle leakage current in response to an external power source providing a charging current to a vehicle. The vehicle leakage current includes a first leakage component and a second leakage component. The balance circuit is further configured to generate a first voltage value that corresponds to a negative value of the first leakage component and to provide a second voltage value that generally corresponds to a positive value of the first leakage component. The balance circuit is further configured to apply the second voltage value to the first voltage value to substantially remove the first leakage component from the vehicle leakage current.

A method for correcting a leakage current during a vehicle charging operation is provided. The method comprises determining a vehicle leakage current in response to an external power source providing a charging current to a vehicle, the vehicle leakage current including a first leakage component and a second leakage component. The method further comprises generating a first voltage value that corresponds to a negative value of the first leakage current and providing a second voltage value that generally corresponds to a positive value of the first leakage component. The method further comprises applying the second voltage value to the first voltage value to substantially remove the first leakage component from the vehicle leakage current.

An apparatus comprising a balance circuit is provided. The balance circuit is configured to receive a sensed current indicative of a vehicle leakage current in response to an external power source providing a charging current to a vehicle, the vehicle leakage current including a direct current (DC) leakage component. The balance circuit is further configured to generate a first voltage value that corresponds to a negative value of the DC leakage component and to provide a second voltage value that generally corresponds to a positive value of the DC leakage component. The balance circuit is further configured to apply the second voltage value to the first voltage value to substantially remove the DC leakage component from the vehicle leakage current.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 depicts an apparatus for correcting a DC bias for leakage current in accordance to one embodiment of the present invention;

FIG. 2 depicts a balance bias circuit in accordance to one embodiment of the present invention; and

FIG. 3 depicts a method for correcting the DC bias for leakage current in accordance to one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

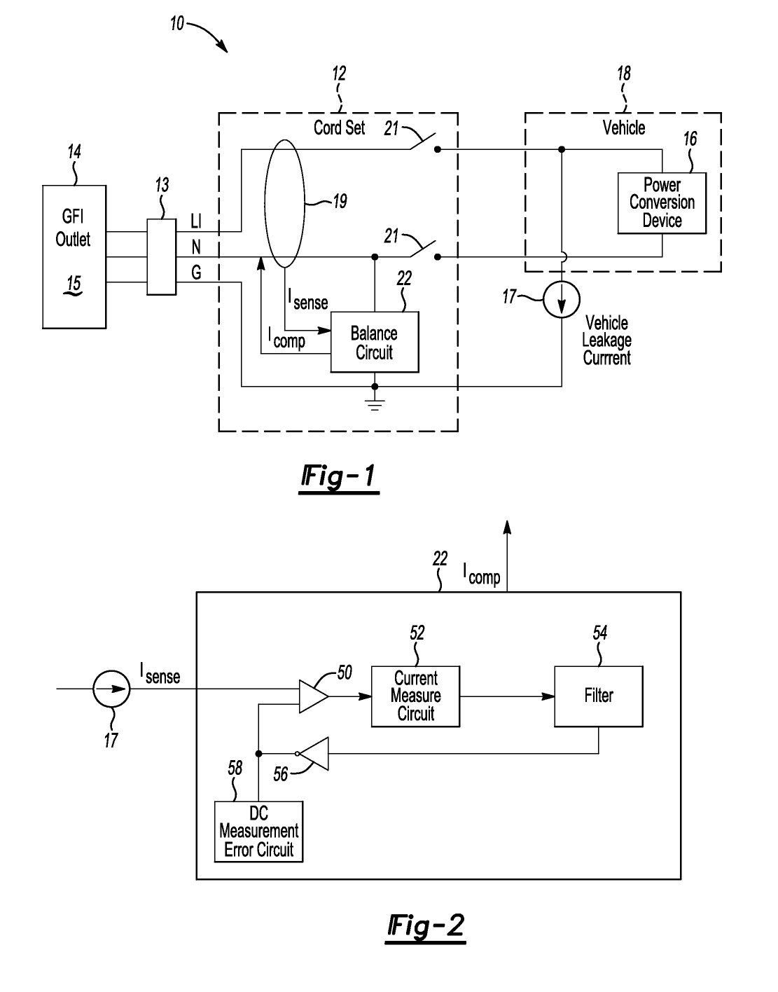

Embodiments of the present disclosure as set forth herein and in FIGS. 1-3 generally describe and/or illustrate a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, RAM, ROM, EPROM, EEPROM, or other suitable variants thereof) and software which co-act with one another to perform operation(s) disclosed herein.

FIG. 1 depicts an apparatus 10 for correcting a DC bias for leakage current in accordance to one embodiment of the present disclosure. It is recognized that the apparatus 10 may correct an alternating current (AC) as well. The apparatus 10 includes a cord set 12. A connection 13 is formed between the cord set 12 and a wall outlet 14. The wall outlet 14 is generally positioned about a residence, commercial establishment, or charging station for providing AC energy to a vehicle 18 for charging the same.

The cord set 12 enables the delivery of AC based energy from a power supply (not shown) operably coupled to the wall outlet 14 (that is equipped with a ground fault interrupt (GFI 15)) to a power conversion device 16 (such as a battery charger or other suitable device) in the vehicle 18. The cord set 12 may be a portable device that is capable of electrically coupling the vehicle 18 to the wall outlet 14. The cord set 12 may include a number of switches 21 that enable electrical transfer between the wall outlet 14 and the vehicle 18. Such switches 21 are generally closed to enable energy transfer to the vehicle 18. In one example, the cord set 12 may also be a device that is positioned within the residence, commercial establishment, or charging station. In another example, the cord set 12 may be incorporated within an on-board computer/controller in the vehicle 18. The power conversion device 16 converts the AC energy into DC energy for storage on one or more batteries (not shown) in the vehicle 18. As depicted, the cord set 12 receives an input line (“L1”), a neutral line (“N”), and ground (“GND”) from the connection 13.

The cord set 12 includes a balance circuit 22 to reduce vehicle AC leakage current (see vehicle leakage current 17 in FIG. 1) to a value that is less than a tripping current of the GFI 15 at the wall outlet 14. During a charging operation, vehicle AC leakage current may exceed the maximum amount of leakage current allowed at the GFI 15. A current sensor 19 provides a current reading that is indicative of the vehicle leakage current 17 (or Iₛₑₙₛₑ) to the balance circuit 22. The current reading received at the balance circuit 22 and depicted as Iₛₑₙₛₑ generally corresponds to the vehicle leakage current 17. The vehicle leakage current 17 may be attributed to a differential resistance that causes input energy flowing from the wall outlet 14 to the vehicle 18 through L1 to be different from the energy flowing from the vehicle 18 back to the wall outlet 14 through N. The vehicle leakage current 17 as shown in FIG. 1 is provided for illustrative purposes.

The balance circuit 22 may adjust the flow of AC current flowing from the vehicle 18 back to the wall outlet 14 (e.g., through N) to be generally similar to the flow of AC current flowing from the wall outlet 14 to the vehicle 18 (e.g., through L1) to prevent undesired tripping at the GFI 15. For example, the balance circuit 22 reduces the amount of vehicle AC leakage current to be less than the maximum amount of leakage current at the GFI 15 to prevent undesired/unwarranted tripping of the GFI 15. The balance circuit 22 provides a compensated current (e.g., I_{comp}) that is indicative of an adjusted amount of AC current that is flowing from the vehicle 18 back to the wall outlet 14. I_{comp} is generally equal to the amount of alternating current that flows from the wall outlet 14 to the vehicle 18 during the charging operation (e.g., between L1 and N to and from the vehicle 18). Because L_{comp} is generally similar to the amount of current flowing to the vehicle 18, such a condition may prevent the GFI 15 from an undesired tripping event. One example of the manner in which the balance circuit 22 reduces (or balances) the leakage current is set forth in co-pending U.S. Ser. No. 12/775,124; entitled “APPARATUS AND METHOD FOR BALANCING THE TRANSFER OF ELECTRICAL ENERGY FROM AN EXTERNAL POWER” filed on May 6, 2010 which is hereby incorporated by reference in its entirety.

The switches 21 may be opened during a charging operation in the event the vehicle leakage current 17 is detected to exceed a predetermined current value for safety purposes. However, if the vehicle leakage current 17 is detected to be below the predetermined current value (i.e., a safe current level), it is still possible for the GFI 15 to experience an undesired tripping event. For example, the GFI 15 may be set to trip at 5 mA and the predetermined current value may be set to 20 mA. If the vehicle leakage current 17 exceeds 5 mA and yet, remains below 20 mA, then the GFI 15 may trip. Such an undesired tripping event could prevent vehicle charging. Thus, the balance circuit 22 may compensate (or balance) for the vehicle leakage current 17 so long as such a current is detected to be below the predetermined current level. In general, the switches 21 are configured to trip faster than the GFI 15 in the event the current exceeds the predetermined current value.

In general, the balance circuit 22 includes any number of electrical devices (or electronics) for enabling the transfer of the AC energy to the vehicle and for balancing the vehicle AC leakage current. A byproduct of such electronics is the presence of a DC leakage current along with the AC leakage current that may be generated when the vehicle is undergoing a charging operation. In one example, the DC leakage current may be generated from various electronics such as amplifier input offset currents or input offset voltages. The DC leakage current may also cause the GFI 15 (in addition to the AC leakage current) to experience unwanted tripping events and may lead to an overall reduction in vehicle charging efficiency due to power loss attributed therefrom. As noted above, the balance circuit 22 may generate I_{comp} to offset the vehicle AC leakage current. The balance circuit 22 may also mitigate or reduce the DC leakage current as will be discussed in more detail below.

FIG. 2 depicts a more detailed implementation of the balance bias circuit 22 in accordance to one embodiment of the present invention. The circuit 22 is generally configured to determine the amount of DC leakage current that is present along with the AC leakage current and to minimize or eliminate the DC leakage current to prevent unwarranted tripping events at the GFI 15 and/or to ensure a high vehicle charging efficiency. The vehicle leakage current 17 (or Iₛₑₙₛₑ as received from the current sensor 19) as depicted in FIG. 2 may include an AC leakage current component (“ACLCC”) and a DC leakage current component (“DCLCC”). The circuit 22 includes an adder circuit 50, a current measure circuit 52, a filter 54, an inverter 56 and a DC measurement error circuit 58. The adder circuit 50 receives Iₛₑₙₛₑ, which includes the ACLCC and the DCLCC. As noted above, the vehicle leakage current 17 in the apparatus 10 may be present during a vehicle charging operation.

The current measure circuit 52 measures the amount of ACLCC and DCLCC that is present in the vehicle leakage current 17. Such information may be stored in memory (not shown). The filter 54 may be implemented as a low pass filter (or other suitable device) to separate the ACLCC from the DCLCC on the vehicle leakage current 17. The filter 54 outputs a voltage that corresponds to the amount of DCLCC that is part of the vehicle leakage current 17. The inverter 56 inverts the voltage output of the filter 54. The circuit 22 uses the ACLCC to output I_{comp}.

The DC measurement error circuit 58 is generally configured to generate a voltage output that corresponds to the DCLCC, which is attributed to various electronics within the apparatus 10. For example, it is known that various electronics (such as, but not limited to, operational amplifiers, comparators, etc.) may be imperfect. The output of such electronics may drift over time and temperature, which can lead to the generation of the DCLCC in the apparatus 10. The electronics and their respective imperfections associated in providing electromagnetic compatibility (EMC) filtering inside the vehicle in connection with performing the battery charging operation may also add to the DCLCC. The DC measurement error circuit 58 is configured to store a voltage that corresponds to the amount of DCLCC by taking into account the imperfections of the various electronics. The filter 54 separates the DCLCC from the ACLCC and passes the DCLCC therethrough. Generally, the circuit 58 may be comprised of, but not limited to, an amplifier and various resistors. The overall formation of the circuit 58 may be formed in a number or arrangements upon recognition of its intended function as is now disclosed herein.

The DC measurement error circuit 58 may take into account various conditions of the electronics which cause the DCLCC such as temperature, offsets, and drifts that are generated therefrom and output an offset voltage that corresponds to the DCLCC. The offset value is stored within the cord set 12 may be a predefined voltage value that is based on the temperature, offsets, or drifts of various electronics used within the apparatus 10 (or various electronics generally used in enabling a vehicle charging operation). The DCLCC may be ascertained by performing circuit analysis of the various electronics in the apparatus 10 to understand the impact of the various temperatures, offset and drifts of the electronics in the apparatus 10.

The DC measurement error circuit 58 outputs a positive voltage value (or offset voltage) that is generally similar to the measured DCLCC. The positive offset voltage, provided from the DC measurement error circuit 58, is summed to the negative value of the DCLCC from the output of the inverter 56. By summing the DCLCC of opposite values at the output of the inverter 56 and at the output of the DC measurement error circuit 58, the DCLCC present in the apparatus 10 may be substantially canceled out, minimized, or negated. The balance circuit 22 outputs I_{comp} which may be similar to ACLCC (e.g., does not include DCLCC which can increase the overall vehicle leakage current and cause undesired tripping events).

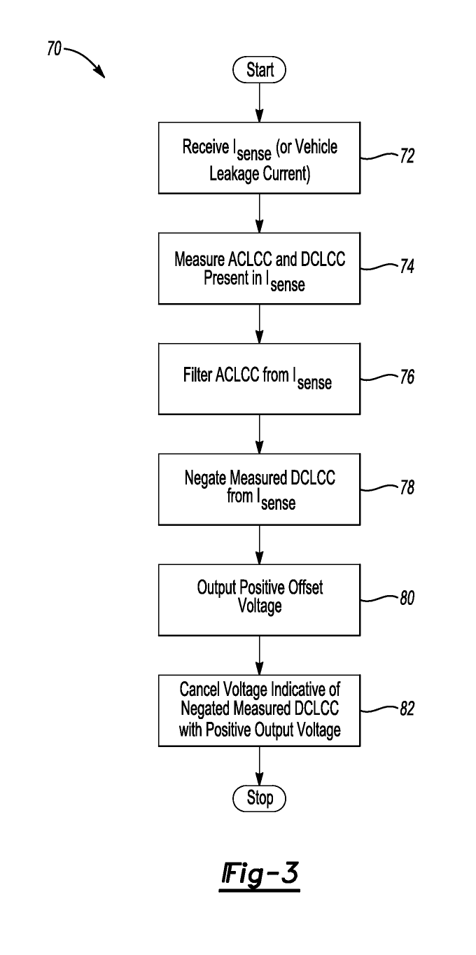

FIG. 3 depicts a method 70 for correcting the DC bias for leakage current in accordance to one embodiment of the present disclosure. The particular order of the operations in the method 70 when performed can be in any order and are not to be limited to only being performed sequentially. The order of the operations may be modified and vary based on the desired criteria of a particular implementation.

In operation 72, the adder circuit 50 receives Iₛₑₙₛₑ from the current sensor 19. As noted above, the current sensor 19 measures current which is generally indicative of the vehicle leakage current 17. The vehicle leakage current 17 is considered to be similar to Iₛₑₙₛₑ.

In operation 74, the current measure circuit 52 measures the ACLCC and the DCLCC that is present on Iₛₑₙₛₑ. The balance circuit 22 generates I_{comp} to balance the AC leakage current that is present vehicle leakage current 17 in response to measuring the ACLCC.

In operation 76, the filter 54 removes the ACLCC from the vehicle leakage current 17 and allows the DCLCC to pass therethrough.

In operation 78, the inverter 56 inverts the DCLCC to generate a negative value of DCLCC once received from the filter 54.

In operation 80, the DC measurement error circuit 58 provides a stored positive offset value of DCLCC. The positive offset value of DCLCC may be a predefined value that is determined based on the various drifts that may occur overtime in connection with the electronics in the apparatus 10. The positive offset of the DCLCC is applied to the negative DCLCCC to cancel out the negative DCLCC.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus for correcting leakage current during a vehicle charging operation, the apparatus comprising:
a balance circuit configured to:
receive a sensed current indicative of a vehicle leakage current in response to an external power source providing a charging current to a vehicle, the vehicle leakage current including a first leakage component and a second leakage component;
generate a first voltage value that corresponds to a negative value of the first leakage component;
provide a second voltage value that generally corresponds to a positive value of the first leakage component; and
apply the second voltage value to the first voltage value to substantially remove the first leakage component from the vehicle leakage current.

2. The apparatus of claim 1 wherein the balance circuit includes an inverter configured to generate the first voltage value in response to the first leakage component.

3. The apparatus of claim 2 wherein the balance circuit includes a filter configured to separate the first leakage component from the second leakage component prior to the inverter generating the first voltage value.

4. The apparatus of claim 3 wherein the filter is a low pass filter.

5. The apparatus of claim 3 wherein the balance circuit includes an error circuit for providing the second voltage value, the second voltage value being a predetermined value that corresponds to various temperature drifts or offsets for electronics positioned in the apparatus.

6. The apparatus of claim 1 wherein the first leakage component corresponds to a direct current (DC) leakage component and the second leakage component corresponds to an alternating current (AC) leakage component.

7. The apparatus of claim 1 wherein the balance circuit is arranged to be operably coupled to a ground fault interrupt (GFI) circuit and the balance circuit is further configured to apply the second voltage value to the first voltage value to substantially remove the first leakage current from the vehicle leakage current to prevent undesired tripping of the GFI circuit.

8. A method for correcting a leakage current during a vehicle charging operation, the method comprising:
determining a vehicle leakage current in response to an external power source providing a charging current to a vehicle, the vehicle leakage current including a first leakage component and a second leakage component;
generating a first voltage value that corresponds to a negative value of the first leakage current;
providing a second voltage value that generally corresponds to a positive value of the first leakage component; and
applying the second voltage value to the first voltage value to substantially remove the first leakage component from the vehicle leakage current.

9. The method of claim 8 further comprising inverting the first leakage component to generate a negative value of the first leakage component prior to generating the first voltage value.

10. The method of claim 9 further comprising separating the first current leakage component from the second current leakage component prior to inverting the first leakage component.

11. The method of claim 8 wherein the second voltage value corresponds to a predetermined value that is based on drifts or offsets for electronics positioned in the vehicle.

12. The method of claim 8 wherein the first leakage component corresponds to a direct current (DC) leakage component and the second leakage component corresponds to an alternating current (AC) leakage component.

13. The method of claim 8 wherein applying the second voltage value to the first voltage value to substantially remove the first leakage component further comprises applying the second voltage value to the first voltage value to substantially remove the first leakage component from the vehicle leakage current to prevent undesired tripping of a GFI circuit positioned external to the vehicle.

14. An apparatus comprising:
a balance circuit configured to:
receive a sensed current indicative of a vehicle leakage current in response to an external power source providing a charging current to a vehicle, the vehicle leakage current including a direct current (DC) leakage component;
generate a first voltage value that corresponds to a negative value of the DC leakage component;
provide a second voltage value that generally corresponds to a positive value of the DC leakage component; and
apply the second voltage value to the first voltage value to substantially remove the DC leakage component from the vehicle leakage current.

15. The apparatus of claim 14 wherein the balance circuit includes an inverter configured to generate the first voltage value in response to the DC leakage component.

16. The apparatus of claim 15 wherein the vehicle leakage current further includes an alternating current (AC) leakage component and wherein the balance circuit includes a filter configured to separate the AC leakage component from the DC leakage component prior to the inverter generates the first voltage value.

17. The apparatus of claim 16 wherein the filter is a low pass filter.

18. The apparatus of claim 16 wherein the balance circuit includes an error circuit for providing the second voltage value, the second voltage value being a predetermined value associated with various temperature drifts or offsets for electronics positioned in the apparatus.

19. The apparatus of claim 16 wherein the balance circuit is arranged to be operably coupled to a ground fault interrupt (GFI) circuit and the balance circuit is further configured to apply the second voltage value to the first voltage value to substantially remove the DC leakage component from the vehicle leakage current to prevent undesired tripping of the GFI circuit.
